(19) United States
(12) Patent Application Publication
(10) Pub. No.: US 2025/0364640 A1
(43) Pub. Date: Nov. 27, 2025

(54) POWER STORAGE DEVICE, POWER STORAGE DEVICE CASE, AND POWER STORAGE DEVICE EXTERIOR MATERIAL

(71) Applicant: DNP HIGH-PERFORMANCE MATERIALS HIKONE CO., LTD., Hikone-shi (JP)

(72) Inventors: Daisuke NAKAJIMA, Hikone-shi (JP); Terutoshi KUMAKI, Hikone-shi (JP)

(73) Assignee: DNP HIGH-PERFORMANCE MATERIALS HIKONE CO., LTD., Hikone-shi (JP)

(21) Appl. No.: 19/294,308

(22) Filed: Aug. 8, 2025

Related U.S. Application Data
(63) Continuation of application No. PCT/JP2024/004648, filed on Feb. 9, 2024.

(30) Foreign Application Priority Data
Feb. 10, 2023 (JP) 2023-019406

(51) Int. Cl. H01M 50/128; H01M 50/105; H01M 50/119; H01M 50/121; H01M 50/124; H01M 50/184; H01M 50/191; H01M 50/193

(52) U.S. Cl. CPC H01M 50/128; H01M 50/105; H01M 50/119; H01M 50/121; H01M 50/1243; H01M 50/184; H01M 50/191; H01M 50/193

(57) ABSTRACT

A power storage device case includes a case body having a top wall, a sidewall at an outer peripheral edge portion of the top wall, and a flange on the outer periphery of the sidewall, and a housing portion enclosed by the top wall and the sidewall. The case body is formed of a power storage device exterior material including a resin base layer, a metal foil layer laminated on an inner surface side of the base layer, a resin heat-resistant barrier layer laminated on an inner surface side of the metal foil layer, and a resin sealant layer and laminated on an inner surface side of the heat-resistant gas barrier layer. An opening portion is formed in the sealant layer to expose the heat-resistant gas barrier layer inside the housing portion, with the outer peripheral edge portion of the opening portion set on the sidewall.

### CROSS-REFERENCE TO RELATED APPLICATIONS

The present application is a continuation application of International Application No. PCT/JP2024/004648, filed on Feb. 9, 2024, which claims priority to Japanese Patent Application No. 2023-019406, filed on Feb. 10, 2023, the contents of which are incorporated herein by reference in their entirety.

### FIELD OF THE INVENTION

The present disclosure relates to a power storage device, such as an all-solid-state battery, which is used as a high-power battery for vehicle applications, a battery for portable devices such as mobile electronic equipment, or a battery for storing regenerative energy, and further relates to a power storage device case and a power storage device exterior material used in such a power storage device.

### BACKGROUND ART

In conventionally widely used lithium-ion secondary batteries, since a liquid electrolyte is used, there has been a risk that the separator may be damaged due to liquid leakage or the formation of dendrites. In some cases, this may result in ignition or the like due to short circuiting.

In contrast, an all-solid-state battery is a battery that uses a solid electrolyte, so liquid leakage and the formation of dendrites do not occur, nor is the separator damaged. Therefore, concerns such as ignition due to separator damage are no longer present, and such batteries have attracted considerable attention from the viewpoint of safety and the like.

A typical all-solid-state battery is constructed such that an all-solid-state battery cell including an electrode active material, a solid electrolyte, and other components is sealed inside an exterior material serving as a casing. In this all-solid-state battery, as research on solid electrolytes progresses, performance requirements for the exterior material that differ from those for exterior materials of conventional batteries using liquid electrolytes have gradually emerged, and various exterior materials have been proposed to satisfy performance requirements for all-solid-state batteries.

An exterior material for an all-solid-state battery has, as a basic structure, a metal foil layer and a heat-fusible layer (sealant layer) laminated on the inner side of the metal foil layer and is configured to seal an all-solid-state battery cell by heat-fusing the sealant layer.

For example, the exterior material for an all-solid-state battery disclosed in Patent Document 1 includes a protective film interposed between a metal foil layer and a sealant layer, and a sealant layer having high hydrogen sulfide gas permeability is used. Furthermore, in the exterior material for an all-solid-state battery disclosed in Patent Document 2, a sealant layer having low hydrogen sulfide gas permeability is used. In addition, in the exterior material for an all-solid-state battery disclosed in Patent Document 3, a sealant layer that absorbs gas is used. Further, in the exterior material for an all-solid-state battery disclosed in Patent Document 4, a vapor-deposited film layer is laminated on the inner surface of the sealant layer.

### PRIOR ART DOCUMENTS

### Patent Documents

Patent Document 1: Japanese Patent No. 6777276
Patent Document 2: Japanese Patent No. 6747636
Patent Document 3: Japanese Unexamined Patent Application Publication No. 2020-187855
Patent Document 4: Japanese Unexamined Patent Application Publication No. 2020-187835

### SUMMARY OF THE INVENTION

### Problems to be Solved by the Invention

However, the conventional all-solid-state batteries have a problem in that gases, such as hydrogen sulfide gas, generated by a reaction between the solid electrolyte and moisture, may leak.

On the other hand, in all-solid-state batteries, the exchange of electrons (ions) occurs through the solid electrolyte during charging and discharging. Therefore, compared with liquid electrolytes, they have higher resistance and generate more heat. However, it is considered that the performance of all-solid-state batteries is not affected even in high-temperature environments. As a result, including Patent Documents 1 to 4, countermeasures for high temperatures (cooling performance) have not been discussed. Nevertheless, as battery technologies continue to evolve toward higher output and capacity, it is fully anticipated that there will be a future demand for improved cooling performance even in all-solid-state batteries.

The above describes the problems in all-solid-state batteries. However, similar problems may also arise in other power storage devices.

Preferred embodiments of the present disclosure have been made in view of the above and/or other problems in the related technologies. The preferred embodiments of the present disclosure are capable of significantly improving existing methods and/or devices.

The present disclosure has been made in view of the above problems. An object of the present disclosure is to provide a power storage device, a power storage device case, and a power storage device exterior material that are capable of preventing the leakage of gases, such as hydrogen sulfide gas, while ensuring sufficient cooling performance.

Other objects and advantages of the present disclosure will become apparent from the following preferred embodiments.

### Means for Solving the Problems

In order to solve the above problems, the present disclosure provides the following means.

[1] A power storage device case comprising:
a case body, the case body being provided with a top wall, a sidewall provided at an outer peripheral edge portion of the top wall, and a flange provided at an outer peripheral edge portion of the sidewall, the case body being configured such that a housing portion is provided inside the top wall and the sidewall,
wherein the case body is formed of a molded article of a power storage device exterior material,
wherein the power storage device exterior material includes a base layer made of resin, a metal foil layer laminated on an inner surface side of the base layer, a heat-resistant gas barrier layer made of resin and laminated on an inner surface side of the metal foil layer, and a sealant layer made of resin and laminated on an inner surface side of the heat-resistant gas barrier layer,
wherein the sealant layer is provided with an opening portion for exposing the heat-resistant gas barrier layer to the housing portion, and
wherein an outer peripheral edge portion of the opening portion is set on the sidewall.

[2] A power storage device comprising:
the case body configured to be used in the power storage device case as recited in the above-described Item [1];
a power storage device cell accommodated in the housing portion of the case body; and
a sealing member heat-sealed to the flange of the case body in a state in which a lower end opening portion of the housing portion in the case body is closed.

[3] The power storage device as recited in the above-described Item [2],
wherein the sealing member includes a base layer made of resin, a metal foil layer laminated on an inner surface side of the base layer, a heat-resistant gas barrier layer made of resin and laminated on an inner surface side surface of the metal foil layer, and a sealant layer made of resin and laminated on an inner surface side of the heat-resistant gas barrier layer, and
wherein the sealant layer of the sealing member is provided with an opening portion for exposing the heat-resistant gas barrier layer of the sealing member to the housing portion.

[4] A power storage device exterior material, the power storage device exterior material being configured to be used in the power storage device case as recited in the above-described Item [1],
wherein the exterior material has a sheet-like shape,
wherein the exterior material includes an opening-intended portion to serve as the opening portion and a sidewall-intended portion to serve as the sidewall, and
wherein an outer peripheral edge portion of the opening-intended portion is set on the sidewall-intended portion.

[5] The power storage device exterior material as recited in the above-described Item 4,
wherein an outer peripheral edge portion of the opening-intended portion is set such that, in a state of the case body, a height of the outer peripheral edge portion of the opening-intended portion is equal to or less than 70% of a forming height of the housing portion.

[6] the power storage device exterior material as recited in the above-described Item 4 or 5,
wherein an outer peripheral edge portion of the opening-intended portion is set such that, in a state of the case body, a height of the outer peripheral edge portion of the opening-intended portion is equal to or more than 20% of a forming height of the housing portion.

[7] The power storage device exterior material as recited in any one of the above-described Items 4 to 6,
wherein an arithmetic mean height Sa as a surface roughness of the heat-resistant gas barrier layer is set in a range of 0.04 μm to 1.5 μm.

### Effects of the Invention

According to the power storage device case of the above-described invention [1], since a heat-resistant gas barrier layer is provided between a metal foil layer and a sealant layer, and an outer peripheral edge portion of an opening portion provided in the sealant layer is formed on a sidewall, good appearance can be ensured. For example, in a case where the outer peripheral edge portion of the opening portion is present on a top wall, the outer peripheral edge portion of the opening portion is pressed by a punch tip surface, and a stepped formed portion may be formed on the top wall, resulting in a poor appearance. In contrast, in the present disclosure, since the outer peripheral edge portion of the opening portion is not present on the top wall, the top wall is free from such molded defects, and good appearance can be ensured. In addition, heat generated from the power storage device cell is efficiently transferred to the metal foil layer through the opening portion and the heat-resistant gas barrier layer without being blocked by the sealant layer, and then dissipated, thereby making it possible to ensure sufficient heat dissipation performance and cooling performance. Furthermore, since the opening portion becomes larger than the top wall, heat dissipation performance and cooling performance can be further improved. Moreover, in the present invention, since the heat-resistant gas barrier layer is disposed on an inner surface side of the metal foil layer, even when hydrogen sulfide gas or the like is generated due to a reaction between a solid electrolyte of the power storage device cell and moisture in the outside air, the gas leakage can be effectively prevented by the heat-resistant gas barrier layer. In addition, since the sealant layer is laminated on the heat-resistant gas barrier layer from the sidewall to the flange, sufficient sealing strength with respect to the heat-resistant gas barrier layer can be obtained, and the occurrence of unintended interlayer delamination can be prevented.

According to the power storage device of the above-described invention [2], in the same manner as described above, good appearance can be ensured. Furthermore, it is possible to reliably prevent the leakage of gases, such as hydrogen sulfide gas, while ensuring sufficient heat dissipation performance and cooling performance.

According to the power storage device of the above-described invention [3], since an opening portion is formed also in the sealant layer of the sealing member, heat dissipation performance and cooling performance can be further enhanced.

According to the power storage device exterior material of the above-described invention [4], in the same manner as described above, when a power storage device is fabricated, good appearance can be ensured. Moreover, sufficient heat dissipation and cooling performance can be achieved, while reliably preventing the leakage of gases such as hydrogen sulfide gas.

According to the power storage device exterior material of the above-described invention [5], it is possible to prevent the occurrence of cracks and pinholes during mold forming. Specifically, although stress tends to concentrate at positions exceeding 70% of a forming height H1 of a sidewall during mold forming, when the opening portion is formed by cutting with a laser cutter or a rotary blade, damage may occur to the heat-resistant gas barrier layer at its outer peripheral edge portion. As a result, stress may concentrate on the damaged portion of the heat-resistant gas barrier layer during mold forming, thereby causing cracks or pinholes. However, in the present disclosure, by setting the outer peripheral edge portion of the opening portion, which may be damaged by laser cutting or the like, to be at a position equal to or less than 70% of the forming height H1, concentration of stress on the damaged portion during mold forming can be avoided, and the occurrence of cracks or pinholes can be prevented. Furthermore, when the outer peripheral edge portion of the opening portion is set at a position equal to or less than 70% of the formed height H1, it becomes possible to ensure a sufficiently large opening area (exposed area of the heat-resistant gas barrier layer), thereby further improving heat dissipation performance and cooling performance.

According to the power storage device exterior material of the above-described invention [6], the sealant layer can secure sufficient sealing strength with respect to the heat-resistant gas barrier layer, thereby preventing unintended interlayer delamination.

According to the power storage device exterior material of the above-described invention [7], the slidability of the heat-resistant gas barrier layer against a forming punch is improved, thereby further improving formability.

### BRIEF DESCRIPTION OF THE DRAWINGS

Some embodiments of the present disclosure are shown by way of example, and not limitation, in the accompanying figures.

FIG. 1 is a schematic cross-sectional view showing an all-solid-state battery as a power storage device according to an embodiment of the present disclosure.

FIG. 2 is a schematic cross-sectional view showing a main part of FIG. 1 in an enlarged manner.

FIG. 3 is an exploded perspective view schematically showing the all-solid-state battery of the embodiment.

FIG. 4 is a bottom view (inner surface view) schematically showing a case body for the all-solid-state battery of the embodiment.

FIG. 5 is a schematic cross-sectional view showing an exterior material for the case body of the all-solid-state battery of the embodiment.

FIG. 6 is a schematic cross-sectional view for explaining a method for forming an opening portion in the exterior material of the embodiment.

FIG. 7 is a schematic cross-sectional view showing a molding apparatus for molding the case body using the exterior material of the embodiment.

FIG. 8 is a schematic cross-sectional view for explaining a heat sealing method in the embodiment.

FIG. 9 is a schematic cross-sectional view showing an all-solid-state battery according to a first modification of the present disclosure.

FIG. 10 is a schematic cross-sectional view showing an all-solid-state battery according to a second modification of the present disclosure.

### EMBODIMENTS FOR CARRYING OUT THE INVENTION

In the following paragraphs, some embodiments in the present disclosure will be described by way of example and not limitation. It should be understood based on this disclosure that various other modifications can be made by those in the art based on these illustrated embodiments.

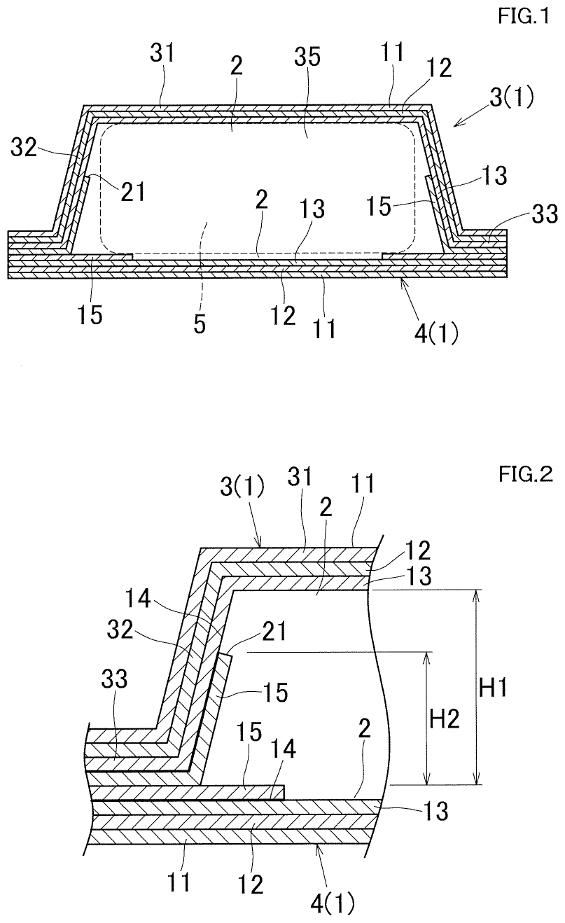

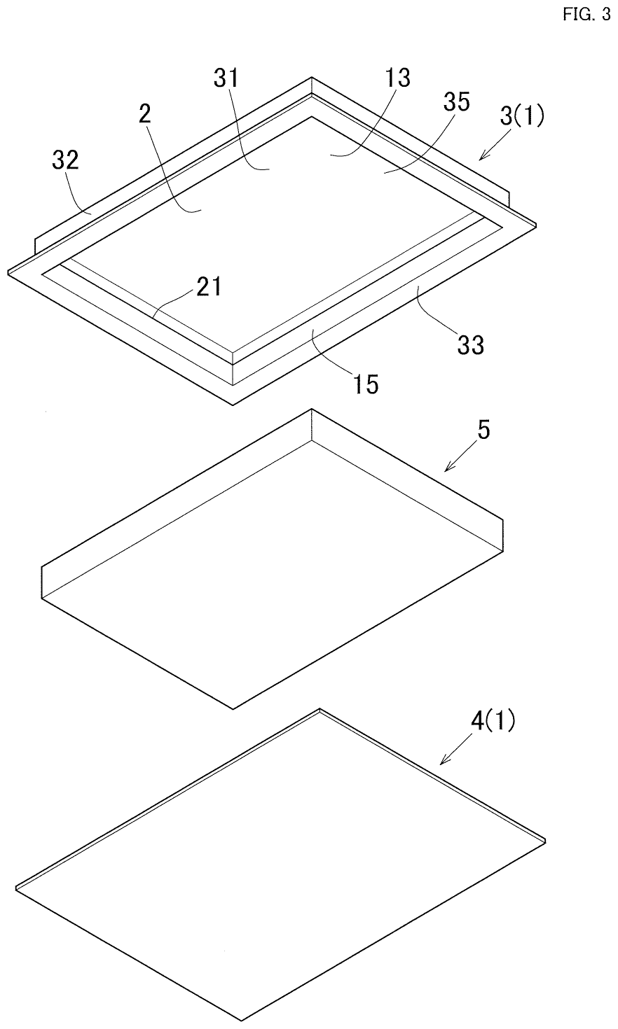

FIG. 1 is a schematic cross-sectional view showing an all-solid-state battery as a power storage device according to an embodiment of the present disclosure. FIG. 2 is a schematic cross-sectional view showing a main part of FIG. 1 in an enlarged manner. FIG. 3 is an exploded perspective view schematically showing the all-solid-state battery of the embodiment. As shown in these drawings, the all-solid-state battery of this embodiment includes a case body 3 and a sealing member 4, which together form a casing, and an all-solid-state battery cell 5 that is housed and sealed in the casing.

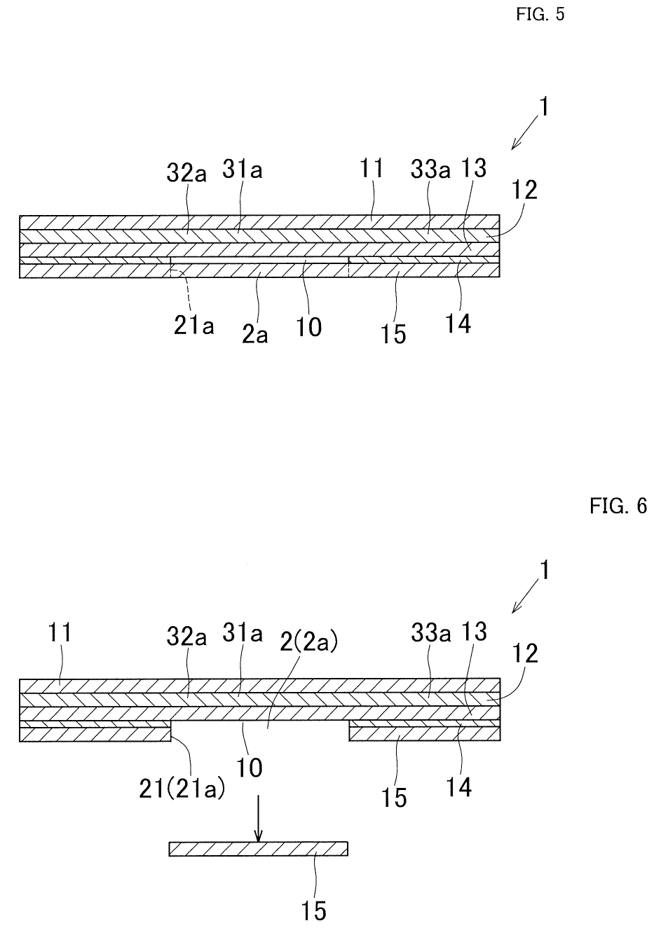

FIG. 5 is a schematic cross-sectional view showing an exterior material 1 forming the case body 3 in the all-solid-state battery of the embodiment. As shown in the drawing, the exterior material 1 includes a base layer 11 disposed on the outermost side, a metal foil layer 12 laminated and bonded to the inner surface side of the base layer 11 via an adhesive layer, a heat-resistant gas barrier layer 13 laminated and bonded to the inner surface side of the metal foil layer 12 via an adhesive layer, and a sealant layer 15 laminated and bonded to the inner surface side of the heat-resistant gas barrier layer 13 via an adhesive layer 14. In the present disclosure, when describing the positional relationship of each layer forming the exterior material 1 in terms of direction, the direction toward the base layer 11 (the upper side in FIG. 3) is referred to as the “outer side,” and the direction toward the sealant layer 15 (the lower side in FIG. 3) is referred to as the “inner side.”

Note that the exterior material 1 used for the sealing member 4 also has the same configuration as the exterior material 1 used for the case body 3.

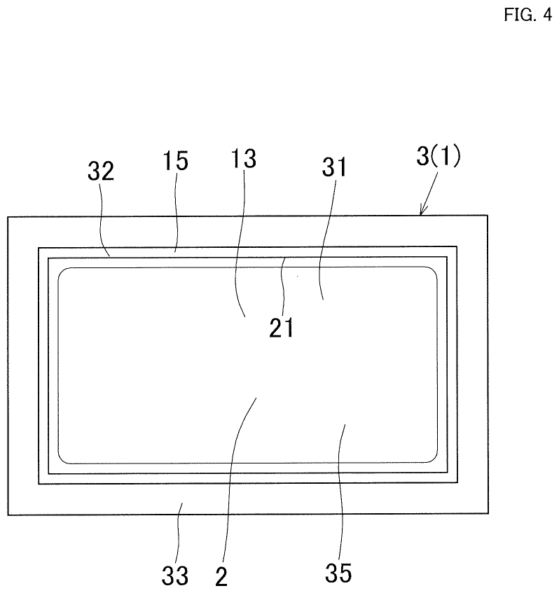

FIG. 4 is a schematic view showing the case body 3 as seen from the bottom side (inner side). As shown in FIGS. 1 to 4, the case body 3 is formed from a molded article of the exterior material 1, and integrally includes a top wall 31, a sidewall (peripheral sidewall) 32 extending downward from an outer peripheral edge portion of the top wall 31, and a flange 33 provided at an outer peripheral lower end portion of the sidewall 32, and a housing portion 35 is formed inside the top wall 31 and the sidewall 32. Further, the sealing member 4 is formed of the sheet-shaped exterior material 1. The all-solid-state battery cell 5 is accommodated in the housing portion 35 of the case body 3, and the sealing member 4 is arranged to close the lower end opening portion of the housing portion 35. The sealing member 4 is arranged such that its sealant layer 15 faces inward (upward), so that the sealant layer 15 of the flange 33 of the case body 3 and the sealant layer 15 of the outer peripheral edge portion of the sealing member 4 are placed to face each other in an overlapping manner. These overlapped sealant layers 15 are integrally joined by heat sealing, thereby producing an all-solid-state battery in which the all-solid-state battery cell 5 is sealed within the casing (case body 3 and sealing member 4).

Further, in the case body 3 of the all-solid-state battery, an opening portion 2 is formed by removing the sealant layer 15 and the adhesive layer 14 in a region corresponding to the housing portion 35. In the sealing member 4 as well, an opening portion 2 is formed by removing the sealant layer 15 and the adhesive layer 14 in the region corresponding to the housing portion 35. Through these opening portions 2 of the case body 3 and the sealing member 4, the heat-resistant gas barrier layers 13 of the exterior materials 1 are exposed inside the housing portion 35 and arranged to face the all-solid-state battery cell 5.

Further, in the all-solid-state battery of this embodiment, although not illustrated, tab leads are provided for electricity extraction. One end (inner end) of the tab lead is bonded and fixed to the all-solid-state battery cell 5, and an intermediate portion thereof extends through a heat-sealed portion between the flange 33 of the case body 3 and the outer peripheral edge portion of the sealing member 4, so that the other end thereof is arranged to extend outward.

Details of each part in the all-solid-state battery of this embodiment will be described below.

The base layer 11 of the exterior material 1 is made of a heat-resistant resin film having a thickness of 5 μm to 50 μm. As the resin used for the base layer 11, stretched polyamide, stretched polyester (PET, PBT, PEN, etc.), stretched polyolefin (PE, PP, etc.), and the like can be suitably used.

The metal foil layer 12 has a thickness set from 5 μm to 120 μm and has a function of blocking penetration of oxygen and moisture from the surface (outer side). As the metal foil layer 12, an aluminum foil, a SUS foil (stainless steel foil), a copper foil, a nickel foil, and the like can be suitably used. In this embodiment, the terms “aluminum,” “copper,” and “nickel” are used to include their alloys as well.

Further, by applying plating or a similar treatment to the metal foil layer 12, the risk of pinhole formation is reduced, and the function of blocking penetration of oxygen and moisture can be further improved.

Furthermore, by performing a chemical conversion treatment, such as a chromate treatment, on the metal foil layer 12, corrosion resistance is further improved, so that the occurrence of defects, such as flaws, can be prevented more reliably. Additionally, adhesion to resin can be improved, thus further enhancing durability.

The sealant layer (heat-sealable resin layer) 15 has a thickness set from 20 μm to 100 μm and is formed of a heat-adhesive (heat-fusible) resin film. As the resin used in the sealant layer 15, polyethylene (LLDPE, LDPE, HDPE), polyolefins, such as polypropylene, olefin-based copolymers, acid-modified products thereof, ionomers, and the like, for example, non-stretched polypropylene (CPP, IPP), can be suitably used.

As the sealant layer 15, considering electrical extraction using tab leads, that is, considering sealing properties, adhesion, and the like with the tab leads, it is preferable to use polypropylene-based resin (non-stretched polypropylene film (CPP, IPP)).

The heat-resistant gas barrier layer 13 is formed of a resin film having heat resistance and insulation properties. Preferred resins for the heat-resistant gas barrier layer 13 include polyamides (such as 6-nylon, 66-nylon, and MXD nylon), polyesters (such as polyethylene terephthalate (PET)), polybutylene terephthalate (PBT), polyethylene naphthalate (PEN), cellophane, polyvinylidene chloride (PVDC), stretched polypropylene (OPP), and the like.

In this embodiment, it is preferable that the resin used to form the heat-resistant gas barrier layer 13 has a predetermined hydrogen sulfide (H₂S) gas permeability. Specifically, the heat-resistant gas barrier layer 13 is preferably formed of a resin having a hydrogen sulfide gas permeability of 15 {cc mm/(m²·D·MPa)} or less, more preferably 10 {cc·mm/(m²·D·MPa)} or less, and still more preferably 4.0 {cc·mm/(m²·D·MPa)} or less, as measured in accordance with JIS K7126-1. That is, when the hydrogen sulfide gas permeability of the heat-resistant gas barrier layer 13 is set to be equal to or less than the above-specified value, it is possible to prevent hydrogen sulfide gas, which is generated by a reaction between the solid electrolyte material and moisture in the outside air, from leaking to the outside through the heat-resistant gas barrier layer 13. In other words, if the hydrogen sulfide gas permeability of the heat-resistant gas barrier layer 13 is too high, the generated hydrogen sulfide gas may leak to the outside through the exterior material 1 (the heat-resistant gas barrier layer 13), which is undesirable.

For reference, the “D” included in the unit of hydrogen sulfide gas permeability stands for “Day (24 h).”

In this embodiment, it is preferable to set the thickness (original thickness) of the heat-resistant gas barrier layer 13 in a range of 3 μm to 50 μm, and more preferably in a range of 10 μm to 40 μm. That is, when the thickness of the heat-resistant gas barrier layer 13 is set within this range, it is possible to reliably achieve the above-mentioned effect of suppressing the permeation of hydrogen sulfide gas and water vapor gas, and even if the sealant layer 15 melts and flows out due to heat adhesion, insulation can be reliably ensured by the heat-resistant gas barrier layer 13. In other words, if the heat-resistant gas barrier layer 13 is too thin, there is a risk that the gas permeation suppression effect and insulation may not be ensured, which is undesirable. Conversely, if the heat-resistant gas barrier layer 13 is too thick, not only is it impossible to reduce the thickness of the exterior material 1, but also no significant effect is gained by increasing the thickness more than necessary, which is also undesirable.

In this embodiment, it is preferable to use a resin film as the heat-resistant gas barrier layer 13. That is, since the entire film serves as the barrier layer, unlike a vapor-deposited film or the like, no barrier cracks occur, thereby improving the barrier performance.

Furthermore, as the resin film used to form the heat-resistant gas barrier layer 13, a non-stretched film or a slightly stretched film can be used, and it is particularly preferable to use a non-stretched film. That is, when a non-stretched film is used, moldability and gas barrier properties can be further improved.

The heat-resistant gas barrier layer 13 of this embodiment has good insulation properties. Even after the all-solid-state battery cell 5 is sealed with the case body 3 and the sealing member 4, which serve as the exterior material 1 of this embodiment, favorable insulation properties can still be ensured.

In this embodiment, it is preferable that the heat-resistant gas barrier layer 13 has an arithmetic mean height Sa, as surface roughness, in the range of 0.04 μm to 1.5 μm. That is, when the surface roughness of the heat-resistant gas barrier layer 13 is within the above-described range, slidability with respect to a forming punch 7 is improved, thereby enhancing formability, which is desirable. In other words, if the arithmetic mean height Sa is less than 0.04 μm, the contact area with the forming punch 7 becomes large, resulting in increased frictional resistance and possible deterioration in formability, which is undesirable. On the other hand, if the arithmetic mean height Sa exceeds 1.5 μm, adhesion defects may occur in the adhesive layer 14, leading to reduced adhesiveness, which is also undesirable.

In this embodiment, a curable adhesive, such as a two-part curing type adhesive, a radiation-curable adhesive (e.g., a UV-curable or X-ray-curable adhesive), and the like, can be used as the adhesive forming the adhesive layer 14, which bonds the heat-resistant gas barrier layer 13 and the sealant layer 15. Among them, a urethane-based adhesive, an olefin-based adhesive, an acrylic-based adhesive, an epoxy-based adhesive, and the like can be suitably used. Furthermore, the thickness of the adhesive layer 14 is set in a range of 2 μm to 5 μm.

In this embodiment, it is preferable to use an adhesive similar to the adhesive used for the adhesive layer 14 to bond the base layer 11 to the metal foil layer 12, and the metal foil layer 12 to the heat-resistant gas barrier layer 13. The thickness of these adhesives is preferably set to the same as that of the adhesive layer 14.

In this embodiment, the outer peripheral edge portion 21 of the opening portion 2 formed in the case body 3 is provided on the sidewall 32 of the case body 3. Furthermore, the opening portion 2 formed in the sealing member 4 is formed corresponding to the lower surface of the all-solid-state battery cell 5.

In this embodiment, in the opening portions 2 formed in the case body 3 and the sealing member 4, no adhesive layer 14 for bonding the sealant layer 15 to the heat-resistant gas barrier layer 13 is provided either. The heat-resistant gas barrier layers 13 are exposed to the inside through the opening portions 2, and in the fabricated state of the all-solid-state battery, the heat-resistant gas barrier layers 13 are arranged to face the upper outer surface and the lower surfaces of the all-solid-state battery cell 5.

In this embodiment, no adhesive layer 14 is provided in the opening portion 2. However, the present disclosure is not limited to this, and the adhesive layer 14 may be partially provided in at least part of the opening portion 2. Nevertheless, as in this embodiment, the absence of the adhesive layer 14 makes it possible to enhance heat dissipation performance.

Here, in this embodiment, as shown in FIG. 2, when the forming height of the housing portion 35 (the distance from the inner surface of the flange 33 to the inner surface of the top wall 31) is defined as “H1,” and the height of the outer peripheral edge portion 21 of the opening portion 2 (the distance from the inner surface of the flange 33 to the upper end of the outer peripheral edge portion 21) is defined as “H2,” it is preferable that the height H2 of the outer peripheral edge portion 21 of the opening portion be set to be equal to or less than 70% of the forming height H1 of the housing portion 35. In other words, it is preferable that the relationship 0.7×H1≥H2 be satisfied. That is, during mold forming, stress tends to concentrate at positions exceeding 70% of the forming height H1 of the sidewall 32 (sidewall-intended portion 32a). The opening portion 2 is formed, as described later, by laser removal, such as laser cutting, before forming. Therefore, there may be a damaged portion at the outer peripheral edge portion 21 of the opening portion due to the laser cutting or the like. If this damaged portion (outer peripheral edge portion 21 of the opening portion) is located at a position exceeding 70% of the forming height H1, stress concentration during forming may cause cracks or pinholes at the damaged portion, which is undesirable. Accordingly, it is preferable that the outer peripheral edge portion 21 (damaged portion) of the opening portion formed by laser cutting be located at a position equal to or less than 70% of the forming height H1, since stress concentration on the damaged portion during forming can be avoided, thereby suppressing the occurrence of cracks or pinholes. Furthermore, when the outer peripheral edge portion 21 of the opening portion is at a position equal to or less than 70% of the forming height H1, it becomes possible to ensure a large opening area of the opening portion 2 (i.e., the exposed area of the heat-resistant gas barrier layer 13), and thus heat dissipation and cooling performance can be further improved.

In this embodiment, it is also preferable that the height H2 of the outer peripheral edge portion 21 of the opening portion be set to be equal to or more than 20% of the forming height H1 of the housing portion 35. That is, since the sealant layer 15 laminated on the heat-resistant gas barrier layer 13 is disposed from the flange 33 to a predetermined height of the sidewall 32, sufficient sealing strength between the sealant layer 15 and the heat-resistant gas barrier layer 13 can be ensured, thereby preventing the occurrence of unintended interlayer delamination and the like.

The size and shape of the opening portion 2 provided in the sealing member 4 are not particularly limited, and it may be larger or smaller than the lower surface of the all-solid-state battery cell 5. To improve heat dissipation performance, it is also preferable that the opening portion 2 of the sealing member 4 be made larger.

In the present disclosure, the sidewall 32 includes a curved portion (corner portion) that connects the flat portion of the sidewall to the flat portion of the top wall 31, and further includes a curved portion (corner portion) that connects the flat portion of the sidewall to the flat portion of the flange 33.

Next, a method for manufacturing the exterior material 1 in this embodiment will be described. In the present disclosure, it should be understood that the method for manufacturing the exterior material 1 is not limited to the method described below. The same applies to the methods for manufacturing the case body 3 and the all-solid-state battery, which will be described later.

In this embodiment, first, a laminate without the sealant layer is manufactured, for example, by a dry lamination method. That is, a resin film for the base layer 11 is bonded to the outer surface of a metal foil (metal foil layer 12) that has undergone, as needed, a surface treatment or a chemical conversion treatment, via an adhesive, and a resin film for the heat-resistant gas barrier layer 13 is bonded to the inner surface of the metal foil via an adhesive. Thus, a laminate without the sealant layer is formed. In this laminate, the metal foil layer 12 and the heat-resistant gas barrier layer 13 are laminated on the inner surface side of the base layer 11.

It should be noted that in manufacturing a laminate without a sealant layer, the laminate may also be produced using an extrusion lamination method. That is, the above-described laminate may be manufactured by laminating a resin composition for the base layer 11 and a resin composition for the heat-resistant gas barrier layer 13 onto the inner and outer surfaces of a metal foil, respectively, while extruding the resin compositions.

Next, a resin film for the sealant layer 15 is bonded to the inner surface (the inner surface of the heat-resistant gas barrier layer 13) of the above-described laminate without the sealant layer via an adhesive (adhesive layer 14), thereby forming the sealant layer 15. Prior to this, adjustment is made such that the portion of the sealant layer 15 corresponding to the opening-intended portion 2a, where the opening portion 2 is to be formed, can be reliably peeled off and removed by the following method.

As shown in FIG. 5, in a first formation method, when forming the sealant layer 15 on the heat-resistant gas barrier layer 13, an adhesive serving as the adhesive layer 14 is applied to the inner surface of the resin film functioning as the heat-resistant gas barrier layer 13 using a gravure roll or the like, and a resin film serving as the sealant layer 15 is bonded via the adhesive layer 14. However, when applying the adhesive to the heat-resistant gas barrier layer 13 using the gravure roll or the like, a non-coated region 10 (where adhesive is not applied) is previously formed at the opening-intended portion 2a. Then, a resin film for the sealant layer is bonded to the heat-resistant gas barrier layer 13 having the non-coated region 10 and dried.

Thereafter, as shown in FIG. 6, the opening-intended portion 2a of the sealant layer 15 corresponding to the non-coated region 10 of the adhesive is cut out using a laser cutter, a rotary blade, or the like (e.g., laser cutting), thereby forming the opening portion 2 (first formation method).

In a second formation method, before applying the adhesive to the heat-resistant gas barrier layer 13, a release paper is temporarily attached to a region corresponding to the opening-intended portion 2a in the heat-resistant gas barrier layer 13. In this state, the adhesive is applied to the heat-resistant gas barrier layer 13 using a gravure roll or the like, and a resin film for the sealant layer 15 is bonded thereto and dried.

Thereafter, the opening-intended portion 2a of the sealant layer 15 corresponding to the temporarily fixed release paper portion is cut out together with the adhesive and the release paper using laser punching, a rotary blade, or the like, thereby forming the opening portion 2. When employing this second formation method, only the resin film for the sealant layer may be removed, or both the resin film for the sealant layer and the adhesive may be removed, or the resin film for the sealant layer, the adhesive, and the release agent may be removed. In other words, the release agent or adhesive may be allowed to remain.

As another formation method, it is also conceivable to form a through-hole as the opening portion 2 in the resin film for the sealant layer 15 before bonding it to the heat-resistant gas barrier layer 13, and to bond the resin film for the sealant layer, which includes the opening portion, to the heat-resistant gas barrier layer 13 via an adhesive (another formation method). However, in this alternative formation method, it is difficult to apply the adhesive uniformly, and it is also difficult to bond the resin film for the sealant layer, including the opening portion, accurately and precisely. Therefore, in this embodiment, it is preferable to adopt the above-described first and second formation methods.

Here, as shown in FIGS. 5 and 6, the sheet-shaped exterior material 1 prior to mold forming includes a top wall-intended portion 31a, which is a portion intended to become the top wall 31, a sidewall-intended portion 32a, which is a portion intended to become the sidewall 32, and a flange-intended portion 33a, which is a portion intended to become the flange 33.

In this embodiment, the outer peripheral edge portion 21a of the opening-intended portion 2a is set within the range of the sidewall-intended portion 32a. Furthermore, the outer peripheral edge portion 21a of the opening-intended portion 2a in the exterior material 1 is set in accordance with the height H2 (see FIG. 2) of the outer peripheral edge portion 21 of the opening portion 2 in the case body 3 after forming.

It should be noted that the exterior material 1 shown in FIGS. 5 and 6 is described as an example in which the exterior material 1 with an opening portion is formed for the case body 3. The same applies to the case where the exterior material 1 with an opening portion is formed for the sealing member 4.

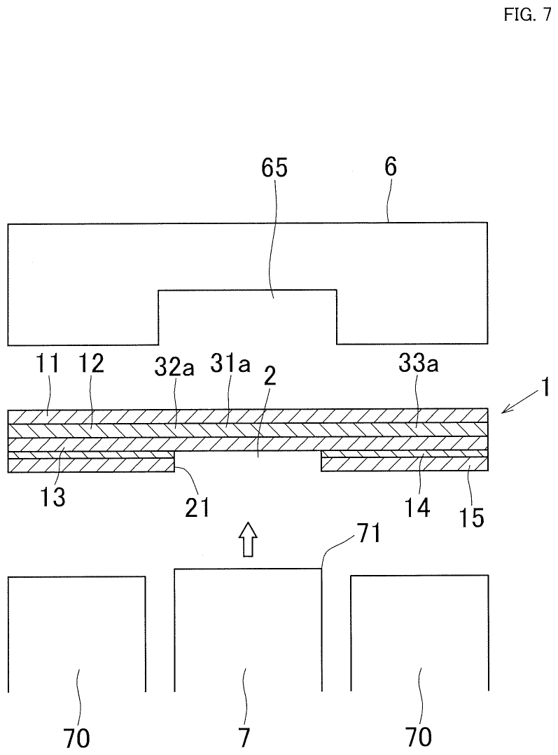

FIG. 7 is a schematic cross-sectional view showing a molding apparatus for forming the case body 3 using the exterior material 1. As shown in the drawing, this molding apparatus includes a die 6 serving as an upper die, and a punch 7 and a wrinkle-preventing die 70 serving as lower dies.

A molding recess 65 for forming the housing portion 35 (top wall 31 and sidewall 32) of the case body 3 is formed on the lower surface side of the die 6.

The punch 7 is arranged corresponding to the molding recess 65 of the die 6, and the wrinkle-preventing die 70 is disposed around the outer periphery of the punch 7 so as to face the outer peripheral portion of the lower surface of the die 6.

Then, the sheet-shaped exterior material 1 with an opening portion, serving as a forming material, is placed such that its sidewall-intended portion 32a corresponds to the outer peripheral edge portion of the tip of the punch 7. In that state, the outer peripheral side of the flange-intended portion 33a of the exterior material 1 is clamped and supported by the outer peripheral portion of the die 6 and the wrinkle-preventing die 70, and the punch 7 is driven into the molding recess 65 of the die 6, thereby pressing the exterior material 1. As a result, a molded body for a case body, having a housing portion 35 (the top wall 31 and sidewall 32) and a flange 33 located outside the housing portion 35, is formed. Subsequently, the flange 33 of the molded body is cut to a predetermined size, thereby producing the case body 3 of this embodiment. In this case body 3, as shown in FIGS. 1 to 4, the opening portion 2 is disposed on the upper part of the housing portion 35, and the outer peripheral edge portion 21 of the opening portion 2 is positioned on the sidewall 32.

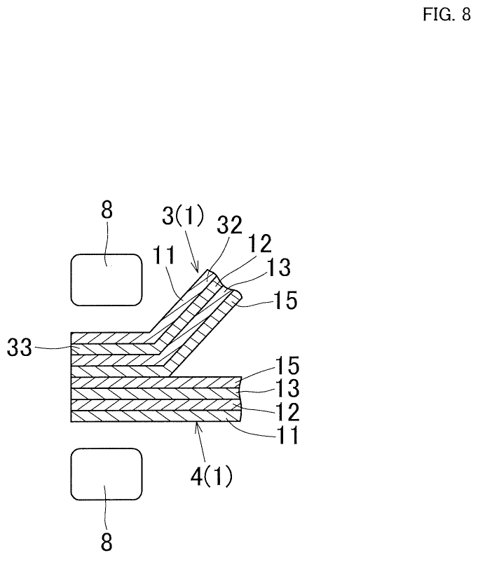

FIG. 8 is a schematic cross-sectional view for explaining a heat sealing method for producing an all-solid-state battery by heat-sealing the case body 3 and the sealing member 4 in this embodiment. As shown in the drawing, in the heat sealing method of this embodiment, a pair of sealing dies 8 is used to heat-seal the flange 33 of the case body 3 and the outer peripheral edge portion of the sealing member 4, which is a sheet-shaped exterior material 1 provided with the opening portion 2 and cut to a predetermined size.

Meanwhile, the all-solid-state battery cell 5 is accommodated in the housing portion 35 of the case body 3 to be heat-sealed, and then the sealing member 4 is arranged so as to close the housing portion 35 from below. At the same time, the sealant layer 15 of the flange 33 in the case body 3 and the sealant layer 15 of the outer peripheral edge portion of the sealing member 4 are arranged to face and overlap each other. In this state, the flange 33 of the case body 3 and the outer peripheral edge portion of the sealing member 4 are clamped and heated by the pair of sealing dies 8. As a result, the overlapping sealant layers 15 are heat-sealed and integrally joined, thereby forming an all-solid-state battery in which the all-solid-state battery cell 5 is hermetically accommodated within the case body 3 and the sealing member 4.

Here, in this embodiment, it is preferable to adjust the resin used for the sealant layer 15 so that the MFR (melt flow rate) is in the range of 2 to 20 g/10 min (230° C., load: 2.16 kgf). That is, when the MFR is within this range, the meltability during heat sealing is improved, allowing resin pooling to occur more easily, thereby enhancing sealing strength. In other words, if the MFR is too low, resin flow during heat sealing becomes poor, making it difficult for resin pooling to occur and potentially leading to a decrease in sealing performance. Furthermore, if the MFR is too high, excessive resin flow during heat sealing may prevent resin pooling from forming, which may also result in reduced sealing performance.

According to the all-solid-state battery of this embodiment having the above-described configuration, the heat-resistant gas barrier layer 13 is provided between the metal foil layer 12 and the sealant layer 15 in the case body 3 and the sealing member 4, and the opening portion 2 is formed in the top wall 31 and the sidewall 32 by removing a part of the sealant layer 15. Therefore, the heat generated from the all-solid-state battery cell 5 is efficiently transferred to the metal foil layer 12 via the opening portion 2 and the heat-resistant gas barrier layer 13 without being blocked by the sealant layer 15, thereby allowing sufficient heat dissipation performance and cooling performance to be secured.

Furthermore, according to the all-solid-state battery of this embodiment, since the heat-resistant gas barrier layer 13 is disposed on the inner surface side of the metal foil layer 12, even if hydrogen sulfide gas or the like is generated due to the reaction of the solid electrolyte of the all-solid-state battery cell 5 with moisture in the outside air, the leakage of such gas can be reliably prevented by the heat-resistant gas barrier layer 13. In addition, due to the gas permeation prevention effect of the heat-resistant gas barrier layer 13, the intrusion of moisture such as water vapor from the outside can be prevented, thereby suppressing the generation of hydrogen sulfide gas itself caused by the reaction of such moisture with the solid electrolyte, and thus more reliably preventing the leakage of hydrogen sulfide gas or the like.

According to the all-solid-state battery of this embodiment, in the case body 3, the sealant layer 15 is laminated over a wide area three-dimensionally on the heat-resistant gas barrier layer 13, from a part of the sidewall 32 to the flange 33. Therefore, the sealant layer 15 can achieve sufficient sealing strength with respect to the heat-resistant gas barrier layer 13, making it possible to prevent the occurrence of unintended interlayer delamination. For example, during measurement of the sealing strength of the sealant layer 15, no peeling stress acts between the sealant layer 15 and the heat-resistant gas barrier layer 13, and thus good sealing strength can be reliably obtained.

In this embodiment, it is preferable to employ, as the resin used for the heat-resistant gas barrier layer 13, a material having a water vapor transmission rate of 50 (g/m²/day) or less, as measured in accordance with JIS K7129-1 (humidity sensor method, 40° C., 90% RH). That is, when this configuration is adopted, the intrusion of moisture can be more reliably prevented by the heat-resistant gas barrier layer 13, and the generation and leakage of hydrogen sulfide gas can also be more reliably prevented.

In this embodiment, it is preferable to employ, as the resin constituting the heat-resistant gas barrier layer 13, a material having a thermal conductivity of 0.2 W/m·K or higher. That is, when this configuration is adopted, the thermal conductivity of the heat-resistant gas barrier layer 13 can be sufficiently ensured, so that the cooling performance of the all-solid-state battery cell 5 can be further improved.

In the all-solid-state battery of this embodiment, the sealant layer 15 is not present between the all-solid-state battery cell 5 and the metal foil layer 12 in the region where the opening portion 2 is formed. However, the insulating heat-resistant gas barrier layer 13 is disposed therebetween, so that insulation can be reliably ensured by the heat-resistant gas barrier layer 13.

In this embodiment, it is preferable to employ, as the resin used for the heat-resistant gas barrier layer 13, a material having a melting point higher by at least 10° C. than that of the resin used for the sealant layer 15. That is, when the heat-resistant gas barrier layer 13 has a high melting point, even if the sealant layer 15 is melted during thermal bonding of the exterior material 1, the flow of the molten material of the heat-resistant gas barrier layer 13 can be prevented. As a result, the gas permeation suppressing effect and insulation provided by the heat-resistant gas barrier layer 13 can be more reliably achieved.

In the all-solid-state battery of this embodiment, since the sealant layer 15 is not formed in the portion of the exterior material 1 corresponding to the all-solid-state battery cell 5, the space for accommodating the all-solid-state battery cell 5 can be made larger (thicker) by that amount corresponding to the absence of the sealant layer. Therefore, in the all-solid-state battery of this embodiment, compared to conventional all-solid-state batteries, it is possible to accommodate a larger-sized all-solid-state battery cell 5 without changing the outer dimensions of the case body 3, thereby enabling thinning while achieving higher output and larger capacity.

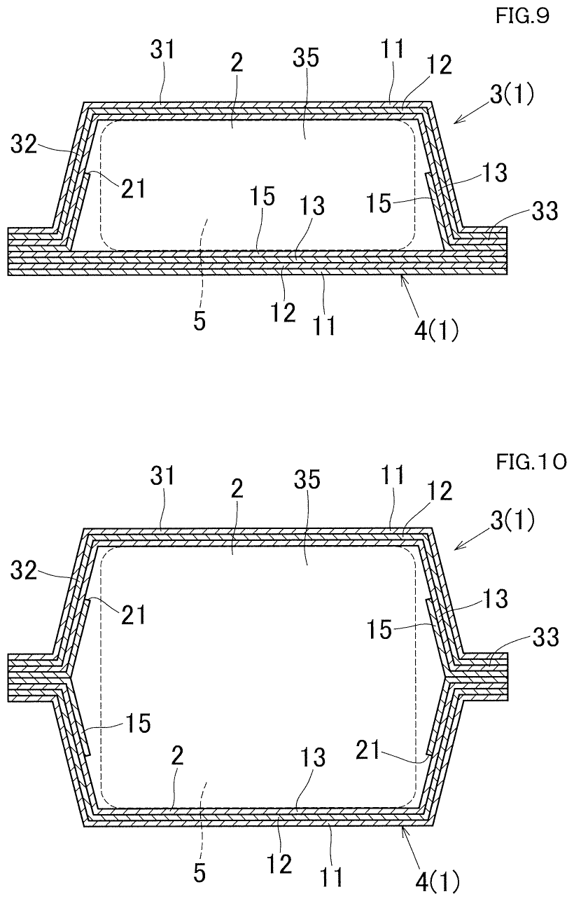

In the above-described all-solid-state battery of this embodiment, the configuration in which the opening portion 2 is formed in both the case body 3 and the sealing member 4 has been described as an example. However, the present disclosure is not limited thereto. As shown in FIG. 9, the opening portion 2 may be formed in the case body 3, and the sealing member 4 may be configured without the opening portion 2.

In the all-solid-state battery of this embodiment shown in FIG. 1, the case body 3 is arranged on the upper side and the sealing member 4 on the lower side. However, the present disclosure is not limited thereto. The all-solid-state battery shown in FIG. 1 may be inverted so that the case body 3, which is a molded article, is arranged on the lower side and the sheet-shaped sealing member 4 on the upper side.

Furthermore, in the present disclosure, a molded article may be used as the sealing member 4. For example, as shown in FIG. 10, a tray-shaped molded article formed by inverting the case body 3 may be used as the sealing member 4, and the casing of the all-solid-state battery may be formed by the case body 3, which is a molded article, and the tray-shaped molded sealing member 4. In this case, by employing the same configuration for the sealing member 4 as that of the case body 3, the same effects can also be achieved in the sealing member 4.

In the above-described embodiment, an all-solid-state battery has been described as an example of the power storage device of the present disclosure. However, the present disclosure is not limited thereto and can also be applied to other power storage devices, including those other than all-solid-state batteries.

The present application claims priority to Japanese Patent Application No. 2023-019406, filed on Feb. 10, 2023, the disclosure of which is incorporated herein by reference.

The terms and expressions used herein are employed for the purpose of explanation and are not intended to be interpreted in a limiting sense. It should be understood that the present disclosure is intended to cover all modifications, equivalents, and alternatives falling within the scope of the appended claims.

It should be understood that the terms and expressions used herein are used for explanation and have no intention to be used to construe in a limited manner, do not eliminate any equivalents of features shown and mentioned herein, and allow various modifications falling within the claimed scope of the present disclosure.

While the present disclosure may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the present disclosure may be embodied in many different forms, a number of illustrative embodiments have been described herein, the present disclosure is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The power storage device exterior material according to the present disclosure can be suitably used as a material for a battery case (casing) for accommodating an all-solid-state battery cell used in an all-solid-state battery or the like.

### BRIEF DESCRIPTION OF REFERENCE SYMBOLS

1: Exterior material
11: Base layer
12: Metal foil layer
13: Heat-resistant gas barrier layer
15: Sealant layer
2: Opening portion
21: Outer peripheral edge portion
2a: Opening-intended portion
21a: Outer peripheral edge portion
3: Case body
31: Top wall
32: Sidewall
32a: Sidewall-intended portion
33: Flange
35: Housing portion
4: Sealing member
5: All-solid-state battery cell
H1: Forming height of the housing portion
H2: Height of the opening portion outer peripheral portion

1. A power storage device case comprising:
a case body, the case body including a top wall, a sidewall provided at an outer peripheral edge portion of the top wall, and a flange provided at an outer periphery of the sidewall, the case body being configured such that a housing portion is provided inside the top wall and the sidewall,
wherein the case body is formed of a molded article of a power storage device exterior material,
wherein the power storage device exterior material includes a base layer made of resin, a metal foil layer laminated on an inner surface side of the base layer, a heat-resistant gas barrier layer made of resin and laminated on an inner surface side of the metal foil layer, and a sealant layer made of resin and laminated on an inner surface side of the heat-resistant gas barrier layer,
wherein the sealant layer is provided with an opening portion for exposing the heat-resistant gas barrier layer to the housing portion, and
wherein an outer peripheral edge portion of the opening portion is set on the side wall.

2. A power storage device comprising:
the case body configured to be used in the power storage device case as recited in claim 1;
a power storage device cell accommodated in the housing portion of the case body; and
a sealing member heat-sealed to the flange of the case body in a state in which a lower end opening portion of the housing portion in the case body is closed.

3. The power storage device as recited in claim 2,
wherein the sealing member includes a base layer made of resin, a metal foil layer laminated on an inner surface side of the base layer, a heat-resistant gas barrier layer made of resin and laminated on an inner surface side of the metal foil layer, and
a sealant layer made of resin and laminated on an inner surface side of the heat-resistant gas barrier layer, and
wherein the sealant layer of the sealing member is provided with an opening portion for exposing the heat-resistant gas barrier layer of the sealing member to the housing portion.

4. A power storage device exterior material, the power storage device exterior material being configured to be used in the power storage device case as recited in claim 1,
wherein the exterior material has a sheet-like shape,
wherein the exterior material includes an opening-intended portion to serve as the opening portion and a sidewall-intended portion to serve as the sidewall, and
wherein an outer peripheral edge portion of the opening-intended portion is set on the sidewall-intended portion.

5. The power storage device exterior material as recited in claim 4,
wherein an outer peripheral edge portion of the opening-intended portion is set such that, in a state of the case body, a height of the outer peripheral edge portion of the opening-intended portion is equal to or less than 70% of a forming height of the housing portion.

6. The power storage device exterior material as recited in claim 4,
wherein an outer peripheral edge portion of the opening-intended portion is set such that, in a state of the case body, a height of the outer peripheral edge portion of the opening-intended portion is equal to or more than 20% of a forming height of the housing portion.

7. A power storage device exterior material as recited in claim 5,
wherein an outer peripheral edge portion of the opening-intended portion is set such that, in a state of the case body, a height of an outer peripheral edge portion of the opening-intended portion is equal to or more than 20% of the forming height of the housing portion.

8. The power storage device exterior material as recited in claim 4,
wherein an arithmetic mean height Sa as a surface roughness of the heat-resistant gas barrier layer is set in a range of 0.04 μm to 1.5 μm.

9. The power storage device exterior material as recited in claim 5,
wherein an arithmetic mean height Sa as a surface roughness of the heat-resistant gas barrier layer is set in a range of 0.04 μm to 1.5 μm.

10. The power storage device exterior material as recited in claim 6,
wherein an arithmetic mean height Sa as a surface roughness of the heat-resistant gas barrier layer is set in a range of 0.04 μm to 1.5 μm.

11. The power storage device exterior material as recited in claim 7,
wherein an arithmetic mean height Sa as a surface roughness of the heat-resistant gas barrier layer is set in a range of 0.04 μm to 1.5 μm.
